(19) United States
(12) Patent Application Publication
(10) Pub. No.: US 2022/0036414 A1
(43) Pub. Date: Feb. 3, 2022

(54) PRODUCT DESCRIPTION-BASED LINE ITEM MATCHING

(71) Applicant: International Business Machines Corporation, Armonk, NY (US)

(72) Inventors: Sampath Dechu, Bangalore (IN); Neelamadhav Gantayat, Bangalore (IN); Harshit Rawat, Bangalore (IN); Sivakumar Narayanan, Bangalore (IN)

(21) Appl. No.: 16/943,457

(22) Filed: Jul. 30, 2020

(51) Int. Cl. G06Q 30/04; G06Q 30/06; G06F 40/30; G06K 9/00

(52) U.S. Cl. CPC G06Q 30/04; G06K 9/00449; G06F 40/30; G06Q 30/0635

(57) ABSTRACT

Methods, systems, and computer program products for product description-based line item matching are provided herein. A computer-implemented method includes obtaining a digital invoice from a vendor comprising one or more text descriptions; retrieving a purchase order corresponding to the digital invoice from a purchase order database, wherein the purchase order comprises one or more line items; applying an out-of-vendor vocabulary model to the one or more text descriptions, wherein the out-of-vendor vocabulary model is trained to remove irrelevant text from the text descriptions based at least in part on historical purchase orders stored in the purchase order database corresponding to the vendor; and matching the one or more text descriptions from the digital invoice to the one or more line items in the purchase order based at least in part on output of the out-of-vendor vocabulary model.

### FIELD

The present application generally relates to information technology and, more particularly, to data analysis techniques.

### BACKGROUND

Account payable (AP) processes typically perform a two-way matching process, wherein the quantity and amount on an invoice are matched to that on the corresponding purchase order (PO). In conventional approaches, such a matching process is time-consuming and prone to errors. Additionally, such conventional approaches are also commonly inefficient and generate numerous false negatives with respect to the matching process.

### SUMMARY

Embodiments of the present disclosure provide techniques for product description-based line item matching. An exemplary computer-implemented method includes the steps of obtaining a digital invoice from a vendor comprising one or more text descriptions; retrieving a purchase order corresponding to the digital invoice from a purchase order database, wherein the purchase order comprises one or more line items; applying an out-of-vendor vocabulary model to the one or more text descriptions, wherein the out-of-vendor vocabulary model is trained to remove irrelevant text from the text descriptions based at least in part on historical purchase orders stored in the purchase order database corresponding to the vendor; and matching the one or more text descriptions from the digital invoice to the one or more line items in the purchase order based at least in part on output of the out-of-vendor vocabulary model.

Another exemplary computer-implemented method includes the steps extracting a plurality of text descriptions from historical purchase orders corresponding to a vendor; generating a set of training data for training a machine learning language model, wherein the generating comprises augmenting at least a portion of the extracted text descriptions with at least one of: (i) one or more domain specific abbreviations associated with the portion of the extracted descriptions, (ii) one or more full forms associated with the portion of the extracted descriptions, and (iii) one or more synonyms associated with the portion of the extracted descriptions; and generating word order variants for each of the extracted text descriptions; training the machine learning language model using the set of training data, wherein the machine learning model identifies whether a given portion of text is relevant to the vendor; and removing irrelevant text from one or more product descriptions of an invoice corresponding to the vendor by applying the trained machine learning language model to the one or more product descriptions.

Another embodiment of the present disclosure or elements thereof can be implemented in the form of a computer program product tangibly embodying computer readable instructions which, when implemented, cause a computer to carry out a plurality of method steps, as described herein. Furthermore, another embodiment of the present disclosure or elements thereof can be implemented in the form of a system including a memory and at least one processor that is coupled to the memory and configured to perform noted method steps. Yet further, another embodiment of the present disclosure or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present disclosure will become apparent from the following detailed description of illustrative embodiments thereof, which is to be read in connection with the accompanying drawings.

### BRIEF DESCRIPTION OF THE DRAWINGS

FIG. 1 is a diagram illustrating a system architecture in accordance with exemplary embodiments;

FIGS. 2A-2D depict an example of product description-based line item matching techniques in accordance with exemplary embodiments;

FIG. 3 is a flow diagram illustrating techniques in accordance with exemplary embodiments;

FIG. 4 is another flow diagram illustrating techniques in accordance with exemplary embodiments;

FIG. 5 is a system diagram of an exemplary computer system on which at least one embodiment of the present disclosure can be implemented;

FIG. 6 depicts a cloud computing environment in accordance with exemplary embodiments; and

FIG. 7 depicts abstraction model layers in accordance with exemplary embodiments.

### DETAILED DESCRIPTION

A two-way matching process within an AP process of financing software, for example, matches a quantity and an amount on an invoice to that on a corresponding purchase order. As noted herein, such processes can be time consuming and error-prone using conventional approaches. Additionally, invoices submitted by vendors in an AP process frequently include other text with descriptions embedded inside the text (for example, provided on a next page or a supplemental page). Existing matching techniques (such as information-retrieval techniques and/or semantic matching techniques) applied directly to such invoices generate an undesirable number of false negatives.

Exemplary embodiments described herein provide improved techniques for product line item matching in, for example, software-based AP systems.

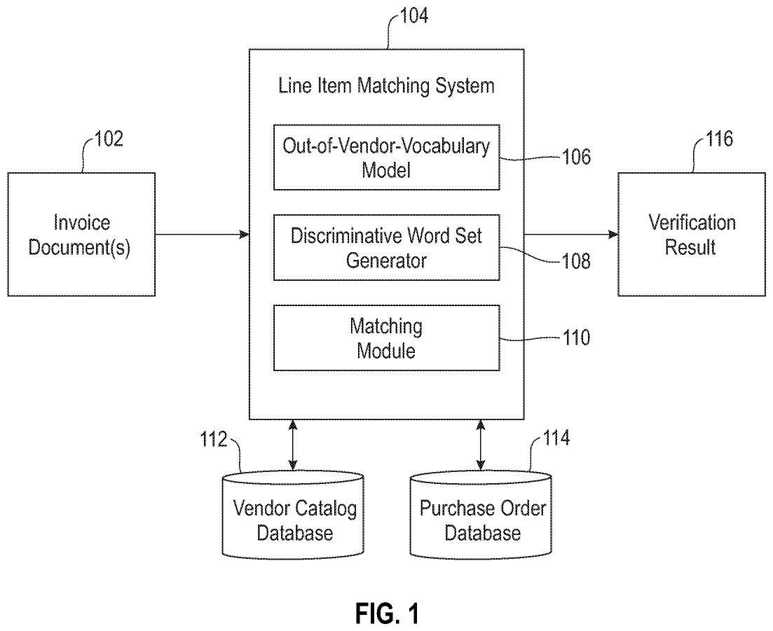

FIG. 1 is a diagram illustrating a system architecture in accordance with exemplary embodiments. By way of illustration, FIG. 1 depicts a line item matching system 104 which includes an out-of-vendor-vocabulary model 106, a discriminative word set generator 108, and a matching module 110. In the FIG. 1 embodiment, the line item matching system 104 communicates with a vender catalog database 112 and a purchase order database 114.

The vendor catalog database 112 includes, for example, information related to a plurality of products for one or more vendors, and the purchase order database 114 includes, for example, information relating to one or more purchase orders. The vendor catalog database 112 may be used to identify particular vendors and associated products that are purchased from that vendor. Such information may be used, for example, to build an out-of-vendor vocabulary, as described in more detail herein.

The line item matching system 104 obtains at least one invoice document 102 in a digital format (for example, PDF, JPEG, etc.). The invoice document 102 may correspond to a purchase order stored in the purchase order database 114 and include, for example, one or more line items with text descriptions for products in the vendor catalog database 112.

The line item matching system 104 extracts content from the invoice document 102 in a structured form. The content may be extracted, for example, by applying key-value pair and table understanding techniques. A non-limiting example of such techniques includes using representation learning to extract structured information from form-like documents (e.g., digital documents and/or scanned images). The process includes using knowledge of the types of the target fields to generate extraction candidates, and a neural network architecture that learns a dense representation of each candidate based on neighboring words in the document.

If present, the line item matching system 104 extracts a purchase order number from the invoice document 102. If no purchase order number is present, then the line item matching system 104 may return an error. The line item matching system 104 identifies the entity who sent the invoice, such as, for example, by matching various attributes of the entity in the invoice with attributes (for example, unique tax identifier, bank account number, fuzzy address match, etc.) from vendor data maintained by an enterprise resource planning (ERP) system. In at least one example embodiment, the line item matching system 104 may be integrated into such an ERP system.

The line item matching system 104 may extract the purchase order line items from historical purchases orders for the vendor. The line item matching system 104 bootstraps the out-of-vendor-vocabulary model 106 using the extracted product descriptions from the line items purchased. As described in more detail herein, the out-of-vendor-vocabulary model 106 is trained to determine whether a particular word is within a vocabulary corresponding to the vendor. The vocabulary for a particular vendor is determined using a set of training data that is based on extracted product descriptions of the historical purchase orders for that vendor. In at least one example embodiment, the set of training data is enhanced based on, for example, domain specific abbreviations, full forms, synonyms, and/or word variants for each product description.

The out-of-vendor-vocabulary model 106 filters out the irrelevant words in the invoice line-item descriptions of the invoice document 102. The line item matching system 104 retrieves the product descriptions from the purchase order that is mentioned on the invoice document 102 and builds a context dependent discriminative word set for each of the descriptions using the discriminative word set generator 108.

For each discriminative word set, the line item matching system 104 checks for existence of a semantically similar word set in the descriptions of the invoice document 102 using the matching module 110, and optionally, determines a matching score indicating a closeness of the match.

The line item matching system 104 then outputs verification result(s) 116 based on the matching. For example, the verification result(s) 116 may indicate whether all of the line items were matched, one or more inconsistencies between the line, and/or the determined matching scores. The results 116 may then be displayed within, for example, a graphical user interface (GUI). A user may then provide feedback via the GUI regarding such results. As a non-limiting example, images, icons, and/or text may be displayed alongside each line item to indicate, for example, the corresponding matching score or inconsistency. This provides, for example, improvements to the usability and efficiency of GUIs for account-payable software based tools when performing tasks such as two-way matching.

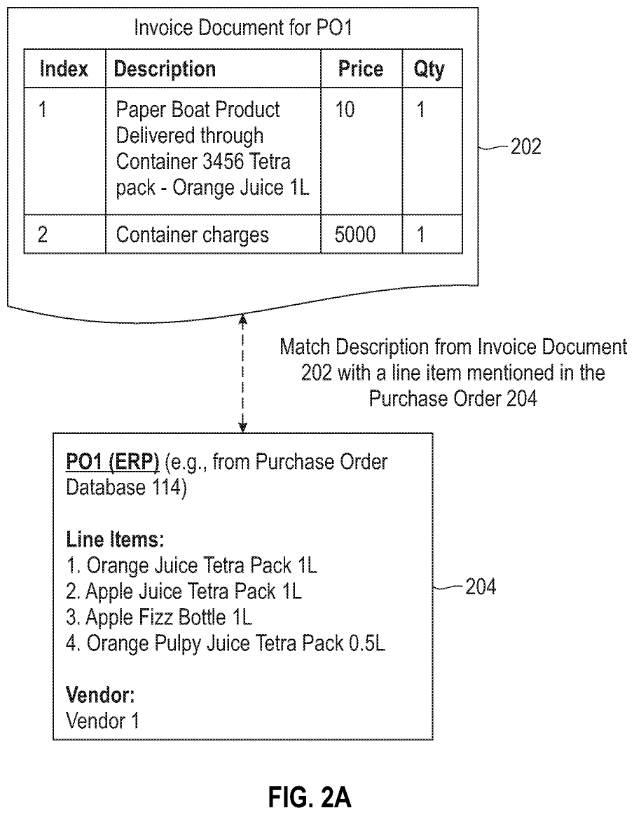

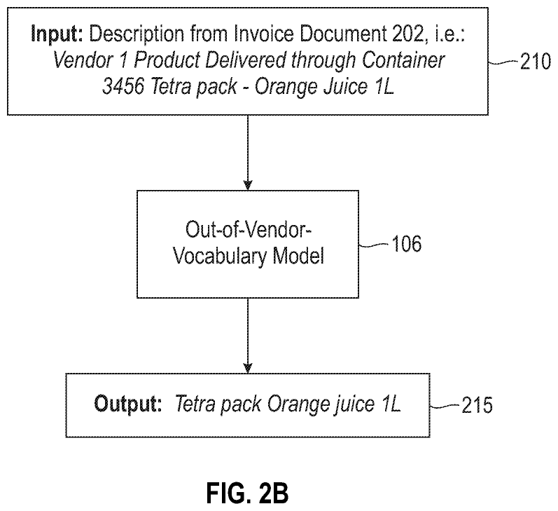

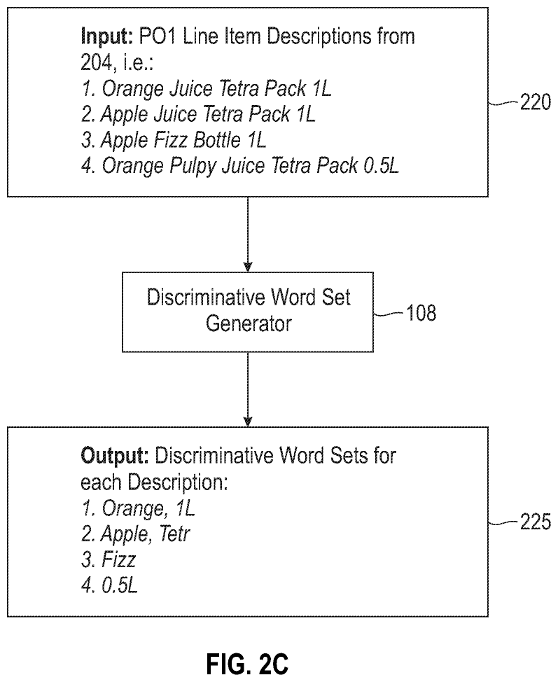

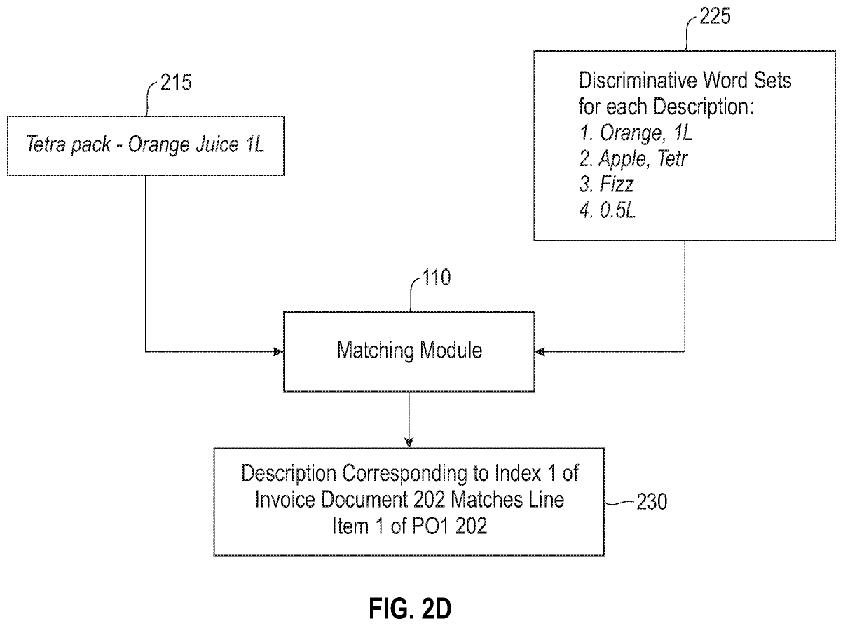

Referring now to FIGS. 2A-2D, these figures depict a non-limiting example of product description-based line item matching techniques in accordance with exemplary embodiments. FIG. 2A depicts an example of an invoice document 202 and a purchase order 204 (for example, from purchase order database 114). The line item matching system 104 matches the descriptions in the invoice document 202 to the line items mentioned in the purchase order 204

FIG. 2B shows the input 210 and corresponding output 215 of out-of-vendor-vocabulary model 106 for the example shown in FIG. 2A. In particular, the input 210 corresponds to the description of index 1 from invoice document 202, namely, “Vendor 1 Product Delivered through Container 3456 Tetra pack—Orange Juice 1 L.” In this example, the out-vendor-vocabulary model 106 removes all content from the input 210 except for “Tetra pack Orange juice 1 L,” which is provided as output 215.

FIG. 2C shows the input 220 and corresponding output 225 of the discriminative word set generator 108. In this example, the input 220 corresponds to the line item descriptions from the purchase order 204, namely:

1. Orange Juice Tetra Pack 1 L

2. Apple Juice Tetra Pack 1 L

3. Apple Fizz Bottle 1 L

4. Orange Pulpy Juice Tetra Pack 0.5 L.

The discriminative word set generator 108 generates the following respective discriminative word sets, which is provided as output 225:

1. Orange, 1 L

2. Apple, Tetra

3. Fizz

4. 0.5 L

In one or more embodiments, each of the context dependent discriminative word sets is defined as a maximal co-occurrence word subset which belongs to one and only one description token set. This can then be mapped into a disjoint sub-set determination problem.

FIG. 2D shows that the output 215 and output 225 are provided as input to the matching module 110. The matching module 110 compares the filtered invoice description to the discriminative word sets. In this example, the words in the set (Orange, 1 L) exist in Tetra pack Orange juice 1 L, thus the matching module 225 matches the invoice description corresponding to index 1 to line item 1 from the purchase order 202.

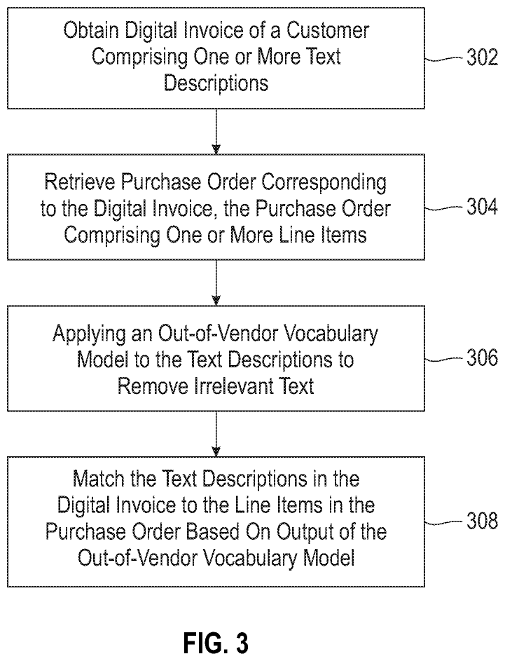

FIG. 3 is a flow diagram illustrating techniques in accordance with exemplary embodiments. Step 302 includes obtaining a digital invoice from a vendor comprising one or more text descriptions. Step 304 includes retrieving a purchase order corresponding to the digital invoice from a purchase order database, wherein the purchase order comprises one or more line items. Step 306 includes applying an out-of-vendor vocabulary model (which can include, for example, at least one machine learning model) to the one or more text descriptions, wherein the out-of-vendor vocabulary model is trained to remove irrelevant text from the text descriptions based at least in part on historical purchase orders stored in the purchase order database corresponding to the vendor. Step 308 includes matching the one or more text descriptions from the digital invoice to the one or more line items in the purchase order based at least in part on output of the out-of-vendor vocabulary model. Also, each of the one or more line items in the purchase order may include a corresponding description.

The matching of step 308 may include generating a context dependent discriminative word set for each of the one or more line items in the purchase order based on the corresponding descriptions. The matching of step 308 may also include matching the one or more text descriptions to the one or more line items based at least in part on the context dependent discriminative word sets.

Additionally, the process of FIG. 3 may include, for a given one of the context dependent discriminative word sets, generating a set of scores based on semantic comparisons of the given context dependent discriminative word set and word sets identified from each of the text descriptions of the digital invoice. The generating the context dependent discriminative word sets may include tokenizing the descriptions corresponding to the one or more line items into respective token sets; and determining a maximal co-occurrence word subset which belongs to one and only one of the token sets. The process may further include extracting a purchase order number from the digital invoice, wherein the purchase order is retrieved from the purchase order database based on the extracted purchase order number.

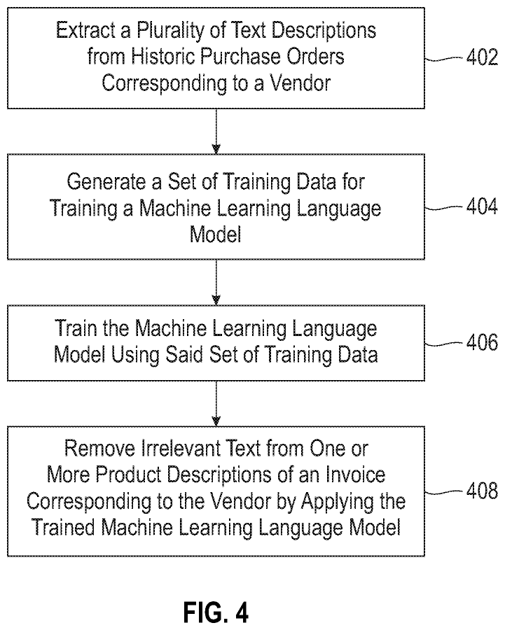

FIG. 4 is a flow diagram illustrating techniques in accordance with exemplary embodiments. Step 402 includes extracting a plurality of text descriptions from historical purchase orders corresponding to a vendor. Step 404 includes generating a set of training data for training a machine learning language model. The generating includes augmenting at least a portion of the extracted text descriptions with at least one of: (i) one or more domain specific abbreviations associated with the portion of the extracted descriptions, (ii) one or more full forms associated with the portion of the extracted descriptions, and (iii) one or more synonyms associated with the portion of the extracted descriptions; and generating word order variants for each of the extracted text descriptions. Step 406 includes training the machine learning language model using the set of training data, wherein the machine learning model identifies whether a given portion of text is relevant to the vendor. Step 408 includes removing irrelevant text from one or more product descriptions of an invoice corresponding to the vendor by applying the trained machine learning language model to the one or more product descriptions.

The techniques depicted in each of FIGS. 3 and 4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the present disclosure, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in each of FIGS. 3 and 4 can be implemented via a computer program product that can include computer useable program code that is stored in a computer readable storage medium in a data processing system, and wherein the computer useable program code was downloaded over a network from a remote data processing system. Also, in an embodiment of the present disclosure, the computer program product can include computer useable program code that is stored in a computer readable storage medium in a server data processing system, and wherein the computer useable program code is downloaded over a network to a remote data processing system for use in a computer readable storage medium with the remote system.

An exemplary embodiment or elements thereof can be implemented in the form of an apparatus including a memory and at least one processor that is coupled to the memory and configured to perform exemplary method steps.

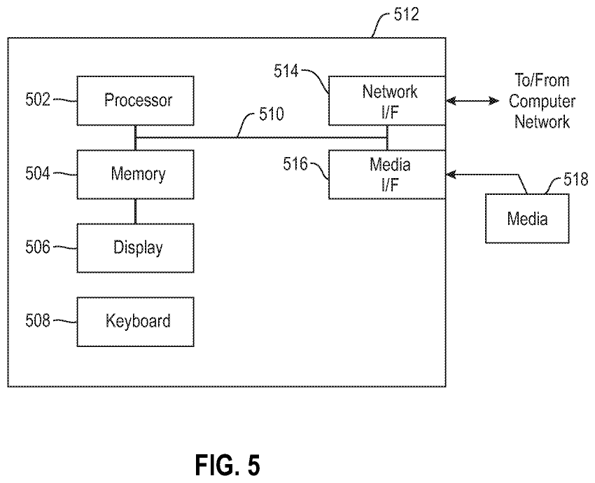

Additionally, an embodiment of the present disclosure can make use of software running on a computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the present disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

An exemplary embodiment may include a system, a method, and/or a computer program product at any possible technical detail level of integration. The computer program product may include a computer readable storage medium (or media) having computer readable program instructions thereon for causing a processor to carry out exemplary embodiments of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present disclosure.

Embodiments of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings provided herein, one of ordinary skill in the related art will be able to contemplate other implementations of the components.

Additionally, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (for example, mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

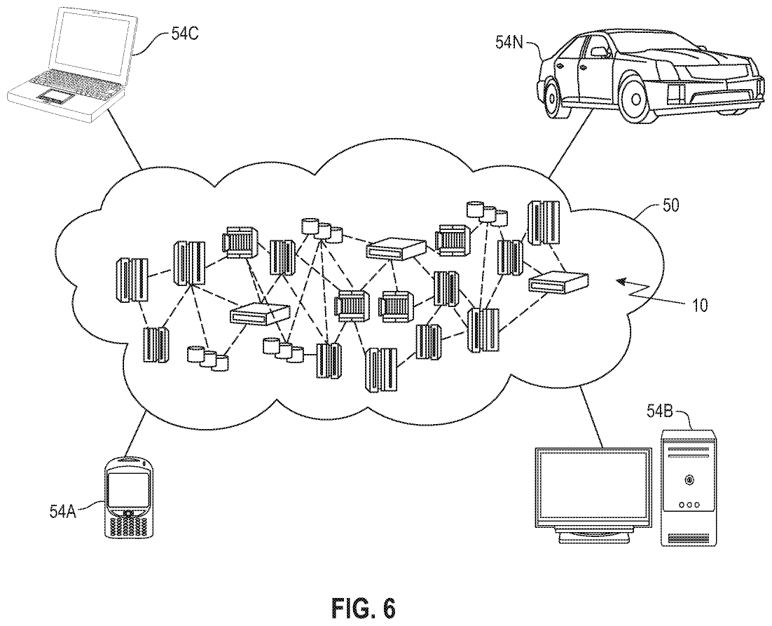

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (for example, using a web browser).

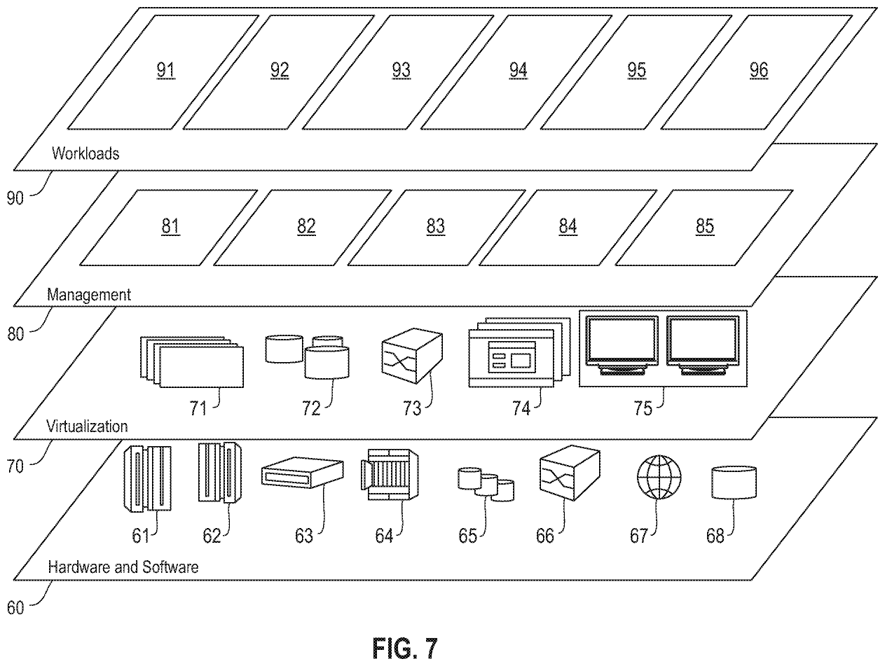

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and product description-based line item matching 96, in accordance with the one or more embodiments of the present disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present disclosure may provide a beneficial effect such as, for example, reducing false negatives in automated line item matching techniques and enabling touchless automation, thereby improving the efficiency of software-based accounting systems and/or tools.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining a digital invoice from a vendor comprising one or more text descriptions;
retrieving a purchase order corresponding to said digital invoice from a purchase order database, wherein said purchase order comprises one or more line items;
applying an out-of-vendor vocabulary model to said one or more text descriptions, wherein said out-of-vendor vocabulary model is trained to remove irrelevant text from said text descriptions based at least in part on historical purchase orders stored in said purchase order database corresponding to said vendor; and
matching said one or more text descriptions from said digital invoice to said one or more line items in said purchase order based at least in part on output of said out-of-vendor vocabulary model;
wherein the method is carried out by at least one computing device.

2. The computer-implemented method of claim 1, wherein each of said one or more line items in said purchase order comprises a corresponding description.

3. The computer-implemented method of claim 2, wherein said matching comprises:
generating a context dependent discriminative word set for each of said one or more line items in said purchase order based on said corresponding descriptions.

4. The computer-implemented method of claim 3, wherein said matching comprises:
matching said one or more text descriptions to said one or more line items based at least in part on said context dependent discriminative word sets.

5. The computer-implemented method of claim 4, comprising:
for a given one of the context dependent discriminative word sets, generating a set of scores based on semantic comparisons of said given context dependent discriminative word set and word sets identified from each of said text descriptions of said digital invoice.

6. The computer-implemented method of claim 3, wherein generating the context dependent discriminative word sets comprises:
tokenizing the descriptions corresponding to the one or more line items into respective token sets; and
determining a maximal co-occurrence word subset which belongs to one and only one of the token sets.

7. The computer-implemented method of claim 1, comprising:
extracting a purchase order number from said digital invoice, wherein the purchase order is retrieved from the purchase order database based on the extracted purchase order number.

8. A computer program product comprising a computer readable storage medium having program instructions embodied therewith, the program instructions executable by a computing device to cause the computing device to:
obtain a digital invoice from a vendor comprising one or more text descriptions;
retrieve a purchase order corresponding to said digital invoice from a purchase order database, wherein said purchase order comprises one or more line items;
apply an out-of-vendor vocabulary model to said one or more text descriptions, wherein said out-of-vendor vocabulary model is trained to remove irrelevant text from said text descriptions based at least in part on historical purchase orders stored in said purchase order database corresponding to said vendor; and
match said one or more text descriptions from said digital invoice to said one or more line items in said purchase order based at least in part on output of said out-of-vendor vocabulary model.

9. The computer program product of claim 8, wherein each of said one or more line items in said purchase order comprises a corresponding description.

10. The computer program product of claim 9, wherein said matching comprises:
generating a context dependent discriminative word set for each of said one or more line items in said purchase order based on said corresponding descriptions.

11. The computer program product of claim 10, wherein said matching comprises:
matching said one or more text descriptions to said one or more line items based at least in part on said context dependent discriminative word sets.

12. The computer program product of claim 11, wherein the program instructions executable by a computing device further cause the computing device to:
for a given one of the context dependent discriminative word sets, generate a set of scores based on semantic comparisons of said given context dependent discriminative word set and word sets identified from each of said text descriptions of said digital invoice.

13. The computer program product of claim 10, wherein generating the context dependent discriminative word sets comprises:
tokenizing the descriptions corresponding to the one or more line items into respective token sets; and
determining a maximal co-occurrence word subset which belongs to one and only one of the token sets.

14. The computer program product of claim 8, wherein the program instructions executable by a computing device further cause the computing device to:
extract a purchase order number from said digital invoice, wherein the purchase order is retrieved from the purchase order database based on the extracted purchase order number.

15. A system comprising:
a memory; and
at least one processor operably coupled to the memory and configured for:
obtaining a digital invoice from a vendor comprising one or more text descriptions;
retrieving a purchase order corresponding to said digital invoice from a purchase order database, wherein said purchase order comprises one or more line items;
applying an out-of-vendor vocabulary model to said one or more text descriptions, wherein said out-of-vendor vocabulary model is trained to remove irrelevant text from said text descriptions based at least in part on historical purchase orders stored in said purchase order database corresponding to said vendor; and
matching said one or more text descriptions from said digital invoice to said one or more line items in said purchase order based at least in part on output of said out-of-vendor vocabulary model.

16. The system of claim 15, wherein each of said one or more line items in said purchase order comprises a corresponding description.

17. The system of claim 16, wherein said matching comprises:
generating a context dependent discriminative word set for each of said one or more line items in said purchase order based on said corresponding descriptions.

18. The system of claim 17, wherein said matching comprises:
matching said one or more text descriptions to said one or more line items based at least in part on said context dependent discriminative word sets.

19. The system of claim 17, wherein generating the context dependent discriminative word sets comprises:
tokenizing the descriptions corresponding to the one or more line items into respective token sets; and
determining a maximal co-occurrence word subset which belongs to one and only one of the token sets.

20. The system of claim 15, wherein the at least one processor is configured for:
extracting a purchase order number from said digital invoice, wherein the purchase order is retrieved from the purchase order database based on the extracted purchase order number.
